(19) United States
(12) Patent Application Publication
(10) Pub. No.: US 2005/0015326 A1
(43) Pub. Date: Jan. 20, 2005

(54) Methods and systems for facilitating investment in real estate

(76) Inventor: Lee N. Terry, Atlanta, GA (US)

Correspondence Address: NORA M. TOCUPS, P.O BOX 698, 140 PINECREST AVE, DECATUR, GA, 30030, US

(21) Appl. No.: 10/867,963

(22) Filed: Jun. 14, 2004

Related U.S. Application Data
(60) Provisional application No. 60/477,477, filed on Jun. 11, 2003.

(51) Int. Cl. G06F 17/60

(52) U.S. Cl. 705/37; 705/35

(57) ABSTRACT

Methods and systems for real estate investment comparable to investment in a company on the stock market. Assets from a common sector are included in an investment fund. The fund assets constitute a representative sample of assets of the common sector. The financial performance of the fund assets as a whole mirrors that of assets of the common sector. An asset may be added or transferred so the fund assets continue to constitute a representative sample of the common sector of assets, and so the value of a share (or like interest) in the fund is unaffected. A trading platform may be provided for buying/selling fund shares. A continually updated web-based reporting system on fund assets may include information on the sale of fund shares, and information on the representative sample of fund assets as a whole such as historical information, in-place value, and forward-looking value to facilitate trading.

### RELATED APPLICATION AND CLAIM FOR PRIORITY

This patent application claims priority to and the benefit of the prior filed co-pending and commonly owned patent application, which has been assigned U.S. Patent Application Ser. No. 60,477,477, which is entitled “Pure-Play Real Estate Trading System (PRETS)”, which was filed on Jun. 11, 2003, and which is incorporated herein by this reference.

### FIELD OF THE INVENTIONS

The inventions relate to investment methods and systems. In particular, the inventions relate to methods and systems that facilitate investment in real estate and other property in a manner comparable to investment in shares in a company traded on a stock market.

### BACKGROUND

Managers of investment portfolios have long known the advantages of a diversified portfolio. Well-diversified portfolios experience less return volatility than do portfolios including only a few assets possessing similar characteristics. The idea of portfolio diversification was formalized by the seminal work of Nobel laureate Harry Markowitz in 1952, who introduced investors to Modern Portfolio Theory (MPT). Markowitz showed statistically how investors can reduce the risk of an investment portfolio through diversification without sacrificing returns. By choosing investment categories (or asset classes) that do no move exactly together—assets that are non-correlating—a portfolio can achieve a desired return with less risk. Today, the principals of portfolio construction developed by Markowitz are the foundation upon which most investment portfolios are constructed by professional investment managers.

Central to portfolio construction is the choice of asset classes (“asset allocation”). In fact, a study by Gary Brinson, Brian Singer, and Gil Beebower, titled “Determinants of Portfolio Performance”, finds that over 90% of the variability in institutional portfolios is a result of asset allocation policy, with only 10% of variability explained by market timing or stock selection. Therefore, portfolio managers devote a substantial amount of time deciding in which asset classes to invest and the percent allocation for each class. Typical asset classes include domestic equities, foreign equities, fixed income, private equities, and real estate. Modern Portfolio Theory (MPT) dictates that asset allocations should be reviewed often by portfolio managers to measure current asset allocations—assets currently held valued at the prevailing market price—versus predetermined asset allocation targets. Following these reviews, portfolios are rebalanced by selling over-allocated asset classes and buying under-allocated asset classes to achieve targeted allocations.

Portfolio managers generally have little difficulty finding assets in which to invest to meet asset allocation targets. Stocks and bonds can easily be bought and sold in the public market. But such is not the case for real estate. The vast majority of United States real estate is owned privately and so is not continually traded and priced in the public domain. The result is that most diversified portfolios are under-weighted in real estate. In fact, except for very large portfolios, real estate is seldom included as a separate asset class of a diversified portfolio. Managers of smaller portfolios usually balance only between stocks, bonds, and cash. The balance is generally limited to stocks, bonds, and cash despite the facts that real estate represents approximately 12% of potential investment assets in the United States, and that real estate has a low correlation to the stock market. Following Modern Portfolio Theory (MPT), this low correlation to the stock market helps to balance risk of a diversified portfolio. In addition, real estate values move favorably with inflation. Property values tend to increase to reflect a higher inflation-driven replacement cost of real estate. Such positive correlation of property value to unexpected inflation counteracts inflation's negative impact on the purchasing power of fixed-income securities held in a diversified portfolio. Unlike other asset classes of a diversified portfolio that benefit from trading in public markets, commercial real estate remains in the inefficient private domain. As a result, real estate does not receive the benefits of efficient public trading such as: higher valuation, liquidity, and continuous pricing.

Arguably, a Real Estate Investment Trust (REIT) could be considered real estate investing in the public domain. In fact, REITs were initially established as the investment vehicle to facilitate investor participation in commercial real estate. But REITs have proven to be an uncertain, if not weak, proxy for a direct investment in real estate. After 40 years of existence, REITs today hold less than 4% of all United States real estate. REITs have been shown to be correlated to the stock market, particularly small-cap stock indexes, with correlation estimates ranging from 30% to 60%. Of more interest is the weak correlation of REITS to direct real estate investment with estimates as low as 20%. Due to these correlations and the resulting uncertainty of REITs as a pure real estate investment (i.e., a “pure-play” in real estate), REITs are usually not considered as a separate real asset class of a diversified portfolio.

Private research performed by Greenwich Associates shows the average institutional investor is in fact under-allocated in real estate. The average targeted allocation for real estate by institutional investors is 4.3% versus an actual allocation of 2.8%. This 1.5% difference represents an approximate $50 billion under-allocation in real estate when all institutional funds are considered. The same under-allocation is likely to exist for private portfolios such as 401(K) plans and for the portfolios of high net worth individuals. It can also be argued that given a more attractive investment vehicle, the targeted asset allocations for real estate would rise making this under-allocation even greater.

The Greenwich study also shows the key reason for an under-allocation in real estate in most portfolios. Ideally, portfolio managers seek investment assets that are continually traded in a public market, possess clear transparency to investment fundamentals, and for which an index exists to measure the performance of assets. Unfortunately, real estate falls far short in all of these areas. REITs could be viewed as closest to an ideal real estate investment. But REITs are operating companies and not pure-plays in real estate. As a result, 60% of the fund managers surveyed consider REITs either too correlated or uncertainly correlated to the overall stock market. Given Modern Portfolio Theory (MPT), this negates any advantage to holding REITs as a separate asset class. In fact, publicly traded REITs constitute a large portion of the major stock indexes such as the Dow Industries and S&P 500. Therefore, an REIT can hardly be considered as a non-correlated asset.

Direct ownership of commercial property (“direct investment”) would obviously be a pure-play non-correlating investment in real estate. But direct investment requires management expertise that most investment managers do not possess. In addition, direct investment is highly illiquid. The lack of management experience and the highly illiquid nature of real estate investment makes rebalancing a diversified portfolio difficult. The purchase and sale of commercial real estate is complicated, time consuming, and expensive. Direct investment in real estate also lacks any efficient valuation. As most real estate transactions are private and infrequent, the valuation of an individual property is difficult and often speculative. Therefore, direct investors in real estate are uncertain as to the value for the purpose of asset allocation decisions necessary to maintain a well-diversified portfolio. Direct investment also requires substantial capital to achieve a diversified group of properties to minimize risk. Such large investment could easily exceed a targeted asset allocation for real estate in most diversified portfolios.

One way to provide diversification for direct investment in real estate is to invest in a professionally co-mingled fund. Such a fund (partnership or other pass-through entity) would combine the real estate allocation of many investors and make direct investments in real estate on their behalf. With such economies of scale, a more diverse pool of real estate assets can be achieved and professional third-party management can be retained. But such investment vehicles lack the essential element of liquidity sought by institutional investors. Buy and sell transactions are still executed in the inefficient private domain. In addition, private equity vehicles lack any continuous valuation of the assets held by the fund. Third-party appraisals could be periodically obtained for each property, but such appraisals typically are untimely, expensive, and generally viewed as unreliable by investors.

In sum, there is a need for a way for a portfolio manager to avoid under-weighting a diversified investment portfolio in real estate. In other words, there is a need for a way to allow a portfolio manager to achieve a well-diversified investment portfolio by including an appropriate percentage of real estate investment in the portfolio.

There is a need for a way to allow for an increase in the percentage of real estate investments in investment portfolios by providing real estate investments with the benefits of efficient public trading including clear transparency to investment fundamentals such as an index or indices for measuring investment performance, continuous trading, easy valuation, higher valuation, liquidity, and continuous pricing.

There is a need for a vehicle of real estate investment other than Real Estate Investment Trusts (REITs), which are not considered a substitute for real estate investment at least because REITs are considered by many to be generally too correlated to the stock market.

There is a need for a way to invest in real estate without direct investment in particular real estate so as to overcome problems including:
the lack of experience and time to directly purchase, manage, sell or otherwise handle direct investments in real estate by investment portfolio managers;
the high illiquidity of direct investments in real estate;
the lack of quick, easy and confident valuations of particular real estate; and
the substantial capital necessary to invest in an appropriate diversity of real estate.

There is a need for a way to invest in real estate other than through professionally co-mingled funds, which share many of the problems mentioned above including the problems of illiquidity and failure of continuous valuation.

### SUMMARY

Stated generally, the inventions include methods and systems that facilitate investment in real estate similar or comparable to investing in a company listed on a stock market.

In sum, real estate assets from a common sector are included in an investment fund. The fund assets constitute a representative sample of assets of the common sector. The financial performance of the fund assets as a whole mirrors that of assets of the common sector. An asset may be added to or transferred from the fund so the fund assets continue to constitute a representative sample of the common sector of assets, and so the value of a share (or like interest) in the fund is unaffected. A web-based (or other) trading platform may be provided for buying/selling fund shares. A continually updated web-based (or other) reporting system on fund assets may include information on the sale of fund shares, and information on the representative sample of fund assets as a whole such as historical information, in-place value, and forward-looking value to facilitate trading.

Advantageously, the inventions provide a way or ways for a portfolio manager to avoid under-weighting a diversified investment portfolio in real estate. The inventions allow a portfolio manager to achieve a well-diversified investment portfolio by including an appropriate percentage of real estate investment in the portfolio.

Another advantage of the inventions is that they allow for an increase in the percentage of real estate investments in investment portfolios by providing real estate investments with the benefits of efficient public trading including clear transparency to investment fundamentals such as an index or indices for measuring investment performance, continuous trading, easy valuation, liquidity, and continuous pricing.

An additional advantage of the inventions is that they allow for investments in real estate without correlation to the stock market, unlike Real Estate Investment Trusts (REITs), which are considered as being generally correlated to the stock market. Yet another advantage of the inventions is that they allow for a way to invest in real estate other than through professionally co-mingled funds, which include problems such as illiquidity and failure of continuous valuation.

A further advantage of the inventions is that they avoid generally the problems of direct investment in real estate. With respect to real estate investment as presented by the inventions described herein, a portfolio manager does not have to devote time nor have experience in the real estate purchasing, management, sale or other activities such as may be necessary in direct investment in real estate. The liquidity of real estate investment according to the inventions contrasts starkly with the high illiquidity of direct investments in real estate. Moreover, the inventions allow for quick, easy, and confident valuations in real estate investments as opposed to the lack of such advantages in direct real estate investment. In addition, the inventions allow for the investment in a diversity of real estate, but do not require substantial capital for such investment as may be required, in contrast, to achieve comparable diversity in direct real estate investment.

The advantages of the inventions may be more clearly understood and appreciated from a review of the following detailed description and by reference to the appended drawings and claims.

### BRIEF DESCRIPTION OF THE DRAWINGS

FIG. 1 illustrates an exemplary transaction flow as may transpire in an exemplary embodiment of the inventions.

FIG. 2 is a flow diagram illustrating relationships among elements and actions as may exist in an exemplary embodiment of the inventions.

### DETAILED DESCRIPTION

The inventions are described below with reference to exemplary embodiments. The disclosed embodiments and examples are intended to be illustrative only since numerous modifications and variations therein will be apparent to those of ordinary skill in the art. In reference to the drawings, like numbers indicate like parts continuously throughout the views. As utilized in the description herein and throughout the claims that follow, the singular includes the plural, and the plural includes the singular.

Generally, the inventions facilitate investment in real estate, and in particular, in commercial real estate. Nonetheless, the inventions may be used in whole or in part and without limitation with respect to other types of property as appropriate.

The inventions include an investment fund, and in particular, an exemplary embodiment includes a real estate investment fund having real estate assets. The real estate investment fund may be referred to herein as the “fund”, the “investment fund”, the “real estate fund”, or otherwise.

A real estate asset of a real estate investment fund may include or constitute one or more real estate properties. A real estate asset may include or constitute real property, improvements on real property, real property including improvements, or even other property in combination or separate from real property and/or improvements on real property.

A real estate asset of the investment fund may be acquired for ownership by purchase of the asset for cash or other monies, and/or the asset may be acquired by a contribution of the real estate asset in exchange for a share or shares in the real estate investment fund. Of course, a real estate asset may be acquired in other ways.

In the exemplary embodiment, the real estate assets of a real estate investment fund belong to the same sector of real estate assets. A “sector” of real estate assets includes assets having at least one characteristic, and sometimes more, in common. Thus, a sector may be of varying breadth or scope depending on the defining characteristic(s) of the sector. Generally, the sector of a real estate investment fund is defined or selected at the time of creation of the fund such as the initial formation of the fund.

Also in the exemplary embodiment, the real estate assets of a real estate investment fund are selected so as to constitute a representative sample of real estate assets belonging to the common sector. Moreover, the real estate assets are selected to serve as the representative sample for the real estate investment fund so that the selected real estate assets have a financial performance as a whole that mirrors (statistically or not) the financial performance of all (or substantially all) of the real estate assets belonging to the common sector as a whole. The number of real estate assets included in a real estate investment fund may vary so long as the included real estate assets constitute a representative sample (based on statistical or non-statistical financial performance) of real estate assets of the common sector.

The exemplary embodiment provides for change in the make up of the assets included as the real estate assets in the real estate investment fund. In the exemplary embodiment, the real estate assets may be added to and/or removed from the real estate investment fund so long as the resulting assets in the fund constitute the representative sample of real estate assets belonging to the common sector. Also in the exemplary embodiment, the real estates also may be added to and/or removed from the real estate investment fund so long as such change does not affect the value of a share in the real estate investment fund.

The exemplary embodiment provides for the sale of shares of ownership in the real estate investment fund. The term “share” is used herein as including a percentage ownership in the fund or a derivative of a share or the like. A “share” also may be referred to as an “interest” or an “ownership interest”.

To facilitate the sale of shares (including the buying, selling, or any other exchange or transaction relating to the shares) of a real estate investment fund, the exemplary embodiment may include a reporting system to provide information (such as a report or reports) relating to the real estate assets of the fund, the shares of the fund, and/or other aspects of the real estate investment fund or otherwise. The reporting system may provide information and/or summarize data on the representative sample of real estate assets of the real estate investment fund as a whole rather than or in addition to providing information on each of the real estate assets in the fund. Thus, a shareholder or potential shareholder is saved the burden of having to read and distill or analyze information on all of the assets included in the fund. Instead, the shareholder or potential shareholder may review the information provided by the reporting system on the fund assets as a whole.

The reporting system of the exemplary embodiment may include historical information on the representative sample of real estate assets as a whole or separately. The reporting system also may include information on the in-place value and/or to the forward-looking value relating to the representative sample of real estate assets as a whole or separately. Further, the reporting system may include information such as historical changes in the rent rolls of the respective real estate assets in the real estate investment fund, and/or historical changes in the rent rolls when the assets in the fund are considered as a whole or separately.

In the exemplary embodiment, the reporting system may be continually updated with information relating to the real estate investment fund, elements thereof (such as the assets and/or the shares of the fund), or the like. For example, the event and/or sales price of a sale of a share or shares in the real estate investment fund may be provided to the reporting system, which may use the information in providing analysis or data on the value of the share or shares or otherwise. The exemplary embodiment may cause the reporting system to be continually updated with information on values and events that relate to the real estate investment fund such as transactions relating to the shares and/or assets of the fund. With such continual updates, the reporting system advantageously provides shareholders and potential investors with up-to-date information such as current value of the shares and/or assets, and similar financial information which allows the investor to assess value.

For convenience, the exemplary embodiment may make the reporting system available on a web-site of a data communications network such as the Internet. The reporting system may be available to the public, or the reporting system (or parts thereof) may be proprietary and restricted. For example, the reporting system may be available via a password or otherwise to shareholders or potential shareholders of the fund. Even though the exemplary embodiment may provide the reporting system on a web-site, the reporting system may be otherwise provided instead of on the web-site or in addition to being on the web-site.

The reporting system may be implemented through the use of application software and a computer system. The implementation of the reporting system may be separate from other elements of the exemplary embodiment, or may be coordinate or communicatively connected to one or more such other elements.

To further facilitate the sale (and other transactions) relating to shares of the real estate investment fund, the exemplary embodiment may provide a trading platform. Shares in the investment fund may be traded, sold, bought, or otherwise exchanged or acted upon through use of the trading platform. Further, the trading platform may be used for transactions relating to other real estate investment funds, or otherwise.

The exemplary embodiment further facilitates the sale and other transactions relating to the shares of the investment fund by providing that the trading platform may be web-based in that the trading platform may be available or accessible at a web-site on the Internet or other data communications network. The trading platform may be made available on the same or on a different web-site from the reporting system described above. Access to the trading platform may be limited as described above with respect to the reporting system of the exemplary embodiment. Alternatively, access to the trading platform may be made available in ways differently from the reporting system, and/or to persons and/or entities different from those who have access to the reporting system or otherwise.

The trading platform may be implemented through the use of application software and a computer system. The implementation of the trading platform may be separate from other elements of the exemplary embodiment (such as the reporting system), or may coordinate or be communicatively connected to one or more such other elements.

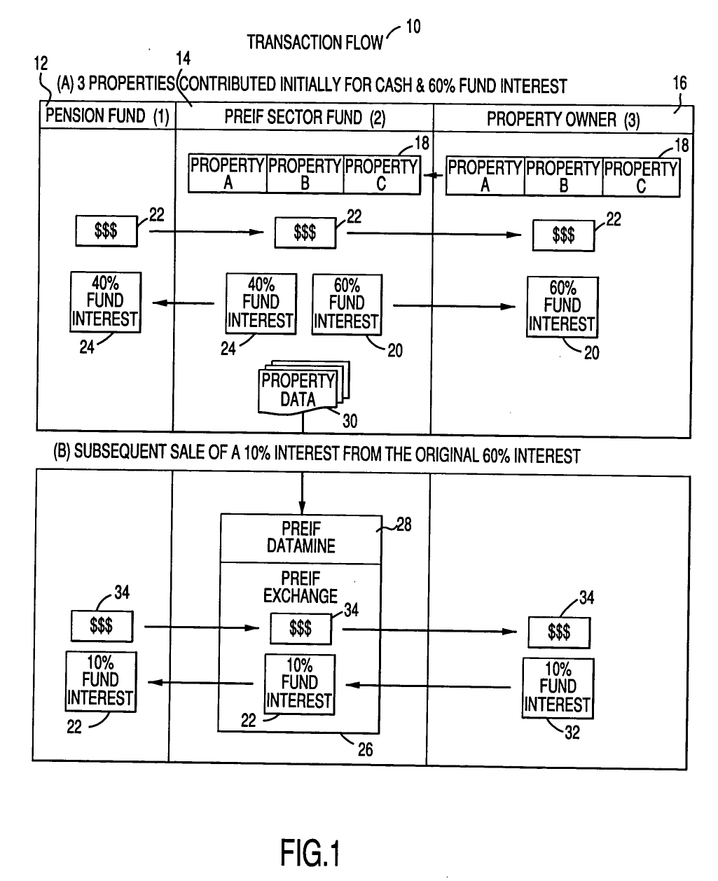

FIG. 1—Exemplary Transaction Flow

As previously noted, the inventions may be directed to systems and methods for investing in commercial real estate. Advantageously, the exemplary systems and methods may transform privately owned heterogeneous commercial real estate into homogeneous marketable securities. This transformation may be achieved through the establishment and operation of one or more such as a series of investment funds (partnerships or other pass-through entities) and an information and trading system (which may be web-based or otherwise). As a short hand for convenience only, the inventions may be referred to as “PREIFs” for Pure-Play Real Estate Index Funds.

FIG. 1 illustrates an exemplary transaction flow 10 for a PREIF. In this example, three entities are involved in a PREIF transaction: a third-party investor 12 (a pension fund in the example), a PREIF sector fund 14 (also referred to as a real estate investment fund or PREIF), and a property owner 16. The property owner 16 contributes three properties 18 to the PREIF 14 in exchange for a percentage interest 20 in the PREIF 14 and cash 22. In this example, the property owner 16 contributes these properties 18 to the PREIF 14 because a contribution of property in exchange for a partnership interest is tax-free under the Internal Revenue Code. In the example, the property owner 16 elects to receive a 60% PREIF interest 20 (tax-free) and the balance of the property value in cash 22 (taxable). Alternatively, PREIFS can purchase property directly from owners not seeking a tax-free transaction. In the example, the remaining 40% PREIF interest 24 is sold to a third-party pension fund 12, which generates the cash portion 24 to be paid to the property owner 16, net of fees.

Repeating the above process numerous times with varying property owners and third-party investors produces a well-diversified pool of sector assets held by a PREIF. The composition of the pool of sector assets for a PREIF is important. The specific real estate sector in which a PREIF invests is defined in the initial formation of a PREIF. Investment in a pool of sector assets versus individual properties differentiates PREIFs from other alternative real estate investments. The characteristics of each sector pool of assets held by a PREIF are statistically determined in the PREIF sytem so that each sector pool is a fair representative sample of the universe of the entire sector. For example, if a Southeast Multifamily PREIF holds 24 properties, those properties are selected so that statistically the financial performance of the 24 properties will mirror the performance of the entire sector. In this manner, PREIFS become index-like investments and unique property risk is eliminated. This converts heterogeneous individual properties into homogeneous fund assts.

PREIFS may be broken into investment units (PREIF shares), which may be continuously traded on the PREIF exchange 26. Alternative real estate funds trade only individual properties with buy-sells executed in the inefficient private domain. But PREIF shares are continuously traded in the efficient public market. Alternative real estate funds can only be valued by unreliable and infrequent appraisals. PREIF shares may be easily and continuously traded in a public market and so may have great advantage over alternative real estate investments. Both provide an exposure to real estate, but only PREIFs are liquid and continuously priced.

Referring again to FIG. 1, PREIF investing may be driven by a web-based information processing system 28 referred to as the “PREIF DateMine” and a trading platform referred to as the PREIF exchange 26. The PREIF DataMine 28 transforms non-standardized individual property data 30 into useful summarized pool data. This transformed data provides the basis for the trading of PREIF shares on the PREIF exchange 26.

The assets held by each PREIF may be managed by third-party management companies. Individual property data 30 may be transmitted continuously by property managers to PREIF asset managers for input into the PREFI DataMine 28. Raw property data is edited and standardized in the PREIF DataMine 28 to produce timely data in a highly useful format. This standardized information flow is the basis upon which investors can make buy-sell decisions for PREIF shares on the PREIF exchange 26.

The example of FIG. 1 shows that subsequent to the contribution of property 18, the property owner 16 decides to sell a 10% PREIF share 32 using the PREIF exchange 26. As the PREIF exchange 26 is an auction-type based trading platform, the PREIF shares 32 are offered on the PREIF exchange 26 at a price by the property owner 16. The offering price may be determined by the property owner 16 relying on the operating data reported in the web-based PREIF DataMine 28. The offered units 32 are matched in the PREIF exchange 26 with third-party investor bids. Bid prices are also based on the date ported in the PREIF DataMine 28. In the example, the 10% PREIF share 32 is transferred to the third party pension fund 12 at the matched price 34 through the PREIF exchange 26.

All completed trades may be immediately reported on the web-based PREIF DataMine 28. This reporting provides the basis for the current valuation of PREIF shares. Since a PREIF is a pass-through investment vehicle, current trades of PREIF shares reflect the current value investors attribute to PREIF sector assets. Stated differently, current trades of PREIF shares set a current value for the pooled real estate held by each PREIF. Subsequent auction trades may be reported resulting in a continuously updated valuation of the real estate assets held by a PREIF. Therefore, real estate assets that were previously owned privately and valued infrequently may be, via the inventions described herein, continuously valued based on actual market trades. Real estate that was previously hard to value, illiquid, time consuming to buy or sell, and characterized by high transaction cost may be now valued efficiently, through the inventions described herein, by a public market, highly liquid, with low transaction cost, and with buy-sells executed immediately. This valuation of real estate assets by the market—not by an unreliable appraisal—in turn provides the basis for valuing new properties to be contributed to a PREIF.

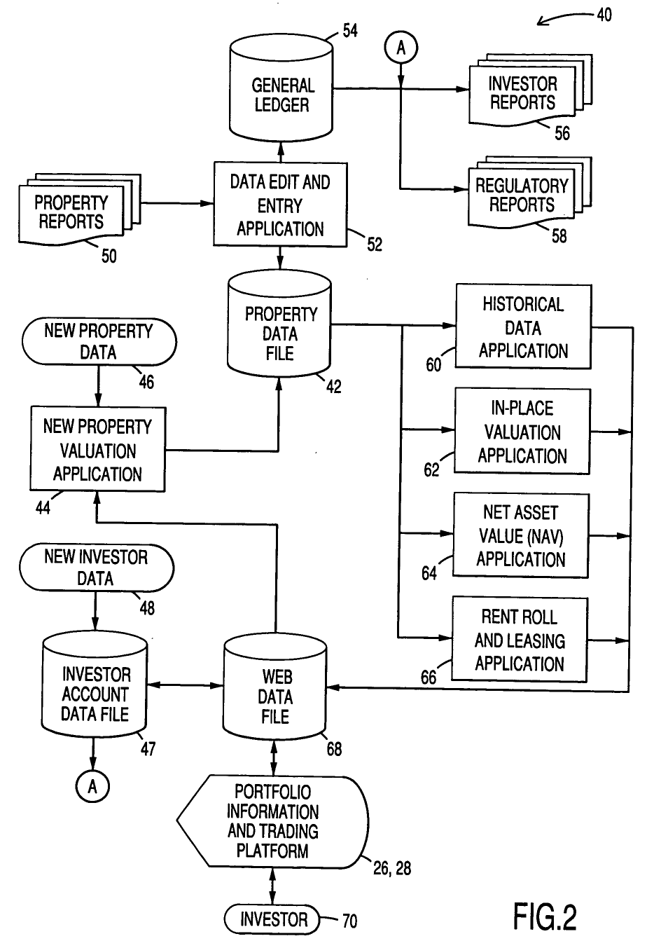

FIG. 2—Relationships Among Elements and Actions of an Exemplary Embodiment of the Inventions

FIG. 2 illustrates relationships and actions 40 that may occur in an exemplary embodiment of the inventions, and specifically with regard to the PREIF DataMine 28 and the PREIF exchange 26.

As properties are added to a PREIF, the property data file 42 may be initialized with data for that property. The new property valuation application 44 underwrites the net operating income (NOI) for a new property using underwriting standards acceptable to third-party investors and based on new property data 46. New property data (also referred to as initialization data) 48 may include (but not be limited to): location and physical data for the property, current lease data, historical financial results, and current year operational and capital budgets.

Another initialization application concerns third-party investors. As third-party investors are qualified for PREIF investment, the investor account date file 28 is initialized with the data for those investors. The investor account data file (also referred to as initialization data) 48 may include (but not be limited to): contact information, trading authorizations, credit limits, and initial bids for PREIF shares.

Day-to-day management of PREIF properties may be contracted to third-party property management companies. Since most property management companies are locally operated, this brings important local market knowledge to leasing and management activities. In addition, the PREIF investment structure allows contributors of property to retain property management, which is often an important source of revenue for those property owners. The disadvantage of third-party management is the multiplicity of reporting formats. To overcome this difficulty, the PREIF DataMine 28 is designed to receive property reports 50 in varying fomats, to edit this data, and to input standardized data into the property data file 42. Input data may include, but not be limited to, financial reports, leasing activity and market information. The data edit and entry function (or application) 52 is designed for quick input of data entry to provide timely information to investors. This is particularly important for significant changes in tenant leases including lease renewals, move-out notices, and new leases.

Raw financial data derived from property reports 50 is standardized and used to update the general ledger 54. This is critical as the investor reports 56 and regulatory reports 58 for the governmental agencies (e.g., the Internal Revenue Service and the Securities and Exchange Commission) are reported at the pool level. Therefore, property data is transformed into a summarized and standardized format for reporting.

Applications within the PREIF DataMine 28 produce the data to report operational results for a PREIF. The reports provide transparency with respect to information that may be used by investors for buy-sell decisions. The exemplary embodiment of real estate investing accomplishes a part of this transparency by sector (index) investing and reporting versus individual property investing and reporting. With sector investing, one property cannot significantly impact the average results of a well-diversified pool. Statistically, a random negative variance of one property is usually offset by the random positive variance of another property. So on-average returns are more predictable and stable. In addition, PREIF reporting formats provide not just summarized standardized reports of real estate fundamentals, but also highly useful analytical reports upon which investor buy-sell decisions can be made. Reports from a multitude of individual properties across many sectors would be confusing and useless to investors. But for a sector of similar properties such reports are easily understood and informative. PREIF sector reports may be viewed as if they represent a single property representing the sector for ease of analysis.

Exemplary specific applications within the PREIF DataMine 28 are now discussed. One application (historical data application) 60 converts the data from the property data file 42 to a standardized format for the reporting of historical results used by the PREIF DataMine 28. The standardized data from this application includes but is not limited to revenue categories, expense categories, capital expenditure categories and leasing activity. This application may be used advantageously because of the multitude of reporting formats received from different local property management companies. Retention of this dat in a standardized format and at the secotr leve is important for the design of derivative products such as puts and calls on real estate sector asets. Without such standardized data for similar sector assets, vairagle necessary to price derivate produces would be useless due to the high volatility of non-standardized generated data.

Another application 62 uses the property data file 42 as input to model and “in-place” value for PREIF shares. Central to this model is a detailed roster of in-place tenants currently occupying space at given rates and terms (“rent roll”). Using rent roll revenue data, standardized expense data, and various assumptions such as capitalization rates, volatility, and other variables, this model stochastically estimates the value of the sector pool of assets on an as-is basis. Because of the PREIF method of investing in well diversified pool of similar sector assets, the statistical accuracy—referred to as the “confidence interval”—of this model is high. This modeled value is used by the PREIF DataMine 28 as an analytical tool for investor buy-sell decisions. This valuation is an important reference point for investors to compare an as-is valuation to a historical valuation using data from the previous application as a measure of operating trends. Such comparisons are performed in the PREIF DataMine 28.

Another application uses the property data file 42 as input to model a “forward looking” value for PREIF shares. Also, central to this model is the in-place rent roll. But unlike the previous model, this model generates values for both the asset and the debt for each individual property to produce a net asset valuation (NAV). Using rent roll revenue data, standardized expense data, and assumptions for asset and debt risk premiums, volatility, and models for the future movements of interest rates, this model stochastically estimates the NAV of the sector pool of assets on a discounted cash flow basis. From this valuation a price for PREIF shares may be derived. Once again, because of the PREIF method of investing modeling of a well diversified pool of similar sector assets, this model reports high statistical accuracy.

These three applications give investors complete visibility into PREIF real estate assets and therefore PREIF shares pricing to make buy-sell decisions. Prices can be viewed based on historical valuations, as-is valuations, and/or expected future valuations. Modeled valuations are used interactively in the PREIF DataMine 28 to allow investors to change model variables to view corresponding changes in PREIF share value estimates. This is in comparison to alternative real estate investments that report static appraisal values based on the assumption of an appraiser without investor input or visibility into the valuation methodology.

The final application 66 uses the property data as input for a model that analyzes the historical changes in each property's rent roll. As each property in the pool is unique, separate analysis of individual rent roll would be too complicated and too difficult to understand. This application standardizes the data for individual properties and reports summarized analyses in highly useful formats. Analytic and rent roll information is then presented for the pool of assets which can be easily understood by investors. This application analyzes leasing activity over time, future lease expirations, and stratified trends in leasing activity.

The above described applications and trading platform are continuously run on PREIF server(s) to update the web date file. This data is accessed as needed by investors through the PREIF DataMine 28. As an interactive system, the PREIF DataMine 28 provides information to investors in a multitude selected by investors. Investors can access information in various combinations of time periods, in gross dollars, in per square foot or per rental unit amounts, as percent of revenue, and/or in graphical form. Valuation models can be viewed in a matrix form as selected by the investor. For example, an investor may choose to view value as a function of volatility and various term structures of interest rates. Recent and historical trade data is also available in a multitude for reporting formats. For example, trades can be viewed in a variety of time frames, with trading volumes, implied risk premiums, and can be compared to changes in either in-place or historical NOI. Such flexibility gives investors clear visibility to the economic fundamentals of PREIF assets in formats that the investors determine as most useful.

Based on this information, investors can enter buy sell orders onto the PREIF exchange 26. Bid and ask prices are matched using an auction methodology. Trades are executed according to the instructions of the investors at either market clearing prices or at fixed prices within a specified time period.

As stated above, the new property valuation application 44 underwrites the NOI for a new property using underwriting standards acceptable to third party investors and new property data. It can now be shown how market trades are input back into this application to price new properties to be added to a PREIF. Implicit in the price at which those PREIF shares trade is the value investors are currently assigning to the actual NOI of a PREIF asset pool. The NOI for the current portfolio of PREIF assets is continuously updated on the PREIF DataMine 28 based on the trading of PREIF shares. Applying the current implied valuation for actual NOI to the underwritten NOI for the new property yields a market value for that property. This property value, net of debt, is converted into the number of new PREIF shares to be issued the contributing property owner as the price for the contributed property.

Additional methodology is used to insure that the derived value of new assets will not dilute the returns currently generated from the existing PREIF assets. For example, the existing debt of the new property is also valued to insure that the NAV value is not diluted. In this sense, PREIFs do not buy assets at a negotiated price; rather, the market continuously values assets that may be added to PREIF sector funds by valuing the NOI of similar assets in a specific sector pool. As new assets are contributed to a PREIF sector pool, the current value—similar to a price-earnings ratio for a stock—for that NOI is allied to the underwritten NOI of the new property. PREIF asset managers underwrite NOI for new property, but the market values that underwritten NOI. This guarantees to investors that a PREIF does not “overpay” for acquisitions, a common concern for alternative real estate funds. Rather, an efficient public market values new assets for PREIF investors.

### CONCLUSION

From the foregoing description of the exemplary embodiments of the inventions and operation thereof, other embodiments will suggest themselves to those skilled in the art. Therefore, the scope of the inventions is to be limited only by the claims below and equivalents thereof.

1. A method for facilitating investment in real estate comparable to investing in a company listed on a stock market, comprising:
acquiring ownership of real estate assets belonging to a common sector for inclusion in a real estate investment fund,
wherein the acquired real estate assets belonging to the common sector and included in the real estate investment fund constitute a representative sample of real estate assets belonging to the common sector,
wherein the representative sample of real estate assets belonging to the common sector comprises real estate assets whose financial performance as a whole mirrors financial performance of real estate assets belonging to the common sector as a whole, and
wherein the common sector comprises real estate assets having at least a characteristic in common;
offering at least a share of ownership or share derivative in the real estate investment fund for sale;
providing a reporting system with respect to the representative sample of real estate assets as a whole,
wherein the reporting system is continuously updated,
wherein the reporting system is available on a web-site accessible by password via a global data communications network,
wherein the reporting system summarizes data on each of the real estate assets constituting the representative sample of real estate assets included in the real estate investment fund, and
wherein the reporting system incorporates information on a sales price relating to the most recent sale of a share or share derivative sold from the real estate investment fund; and
providing a trading platform for buying of shares or share derivatives in the real estate investment fund and for selling of shares or share derivatives in the real estate investment fund,
wherein the trading platform is available on the web-site, and
wherein information on the buying and selling of shares and share derivatives is continually incorporated in the reporting system on the representative sample of real estate assets as a whole.

2. The method of claim 1, wherein the information on the buying of shares or share derivatives and the selling of shares or share derivatives on the trading platform reflects the value of a share or a share derivative in the real estate investment fund.

3. The method of claim 1, wherein the representative sample of real estate assets belonging to the common sector comprises the real estate assets whose statistical financial performance as a whole mirrors the financial performance of the real estate assets belonging to the common sector as a whole.

4. The method of claim 1, further comprising:
prior to the acquisition of ownership of the real estate assets for the real estate investment fund, defining the common sector from which the real estate assets for the real estate investment fund are to be acquired.

5. The method of claim 1, wherein the acquisition of ownership of the representative sample of real estate assets belonging to the common sector comprises acquiring ownership of a real estate asset as part of the representative sample of real estate assets by a contribution of the real estate asset in exchange for a share or shares in the real estate investment fund.

6. The method of claim 1, further comprising:
acquiring ownership of an additional real estate asset belonging to the common sector for inclusion in the real estate investment fund such that the acquired real estate assets including the additional real estate asset in the real estate investment fund continue to constitute the representative sample of real estate assets belonging to the common sector.

7. The method of claim 1, further comprising:
transferring ownership of a real estate asset included in the real estate investment fund so that the remaining real estate assets in the real estate investment fund continue to constitute the representative sample of real estate assets belonging to the common sector.

8. The method of claim 1, further comprising:
acquiring ownership of an additional real estate asset belonging to the common sector for inclusion in the real estate investment fund such that the change in real estate assets in the real estate investment fund does not affect the value of a share in the real estate investment fund.

9. The method of claim 1, further comprising:
transferring ownership of a real estate asset out of the real estate investment fund without affecting the value of a share in the real estate investment fund.

10. The method of claim 1, wherein the reporting system comprises historical information on the representative sample of real estate assets as a whole.

11. The method of claim 1, wherein the reporting system comprises information on an in-place value relating to the representative sample of real estate assets as a whole.

12. The method of claim 1, wherein the reporting system comprises information on a forward-looking value relating to the representative sample of real estate assets as a whole.

13. A method for facilitating investment in real estate, comprising:
acquiring ownership of a representative sample of real estate assets belonging to a common sector for a real estate investment fund;
converting data on each of the real estate assets into a report relating to the real estate assets as a whole as the representative sample of real estate assets belonging to the common sector; and
offering at least a share of ownership in the real estate investment fund for sale.

14. The method of claim 13, wherein the representative sample of real estate assets comprises real estate assets whose financial performance as a whole mirrors financial performance of the real estate assets belonging to the common sector as a whole.

15. The method of claim 13, wherein the report comprises:
information on historical information on financial performance of the real estate assets as a whole as the representative sample of real estate assets belonging to the common sector;
an in-place value for a share of the real estate investment fund; and
a forward-looking value for a share of the real estate investment fund.

16. The method of claim 15, wherein the historical information comprises historical changes in the rent rolls of the respective real estate assets in the real estate investment fund.

17. The method of claim 13, further comprising:
obtaining a sales price received for a share of ownership in the real estate investment fund; and
using the sales price as part of the report.

18. A method to allow for buying and selling of interests in real estate like shares of companies bought and sold on a stock exchange, comprising:
acquiring real estate assets for a real estate fund,
the acquired real estate assets having at least a common characteristic, and
the performance of the acquired real estate assets representing the performance of all real estate assets having at least the common characteristic; and
selling interests in the real estate fund.

19. The method of claim 18, further comprising:
providing information on value of an interest in the real estate fund.

20. The method of claim 19, further comprising:
using price information relating to a sold interest in the real estate fund as part of the information provided on the value of the assets.
